(19) United States
(12) Patent Application Publication
(10) Pub. No.: US 2019/0248502 A1
(43) Pub. Date: Aug. 15, 2019

(54) BATTERY COMPARTMENT

(71) Applicant: SZ DJI TECHNOLOGY CO., LTD., Shenzhen (CN)

(72) Inventors: Yin TANG, Shenzhen (CN); Jiangang FENG, Shenzhen (CN)

(21) Appl. No.: 16/394,680

(22) Filed: Apr. 25, 2019

Related U.S. Application Data
(63) Continuation of application No. PCT/CN2016/113285, filed on Dec. 29, 2016.

(30) Foreign Application Priority Data
Oct. 25, 2016 (CN) 201621166404.9

(51) Int. Cl. B64D 27/24; B64D 27/26; B64C 39/02

(52) U.S. Cl. CPC B64D 27/24; B64C 2201/042; B64C 39/024; B64D 27/26

(57) ABSTRACT

A battery compartment includes a body including a mounting cavity, and a first mounting arm and a second mounting arm each extending from the body toward a direction away from the mounting cavity. Each of the first mounting arm and the second mounting arm includes a mounting member. The mounting member of the first mounting arm is configured to mount a first component and orient the first component toward a first side of the body. The mounting member of the second mounting arm is configured to mount a second component and orient the second component toward a second side of the body. The second side is different from the first side.

### CROSS-REFERENCE TO RELATED APPLICATIONS

This application is a continuation of International Application No. PCT/CN2016/113285, filed on Dec. 29, 2016, which claims priority to Chinese Application No. 201621166404.9, filed on Oct. 25, 2016, the entire contents of both of which are incorporated herein by reference.

### TECHNICAL FIELD

The present disclosure relates to aircraft technology and, more particularly, to a battery compartment, a battery-compartment assembly having the battery compartment, and an unmanned aerial vehicle (UAV) having the battery-compartment assembly.

### BACKGROUND

An unmanned aerial vehicle (UAV) is a flying apparatus that is rapidly developing. The UAVs are flexible and have a rapid response, an unmanned flying capability, and low operation requirements. Currently, the application of UAVs has been expanded to the military field, scientific research filed, and civilian use field. For example, the UAVs have been performing various tasks in fields, including power, communications, weather, agriculture, oceanography, exploration, photography, disaster prevention and mitigation, crop estimation, anti-drug, border patrol, anti-terrorism, or the like. In order to perform better tasks, the UAVs are equipped with multiple types of sensor to provide information and data for obstacle avoidance, positioning, speed measurement, navigation, or other functions. However, the sensors are generally arranged in front of the UAVs, and hence limited information and data are provided for the UVAs.

### SUMMARY

In accordance with the disclosure, there is provided a battery compartment including a body including a mounting cavity, and a first mounting arm and a second mounting arm each extending from the body toward a direction away from the mounting cavity. Each of the first mounting arm and the second mounting arm includes a mounting member. The mounting member of the first mounting arm is configured to mount a first component and orient the first component toward a first side of the body. The mounting member of the second mounting arm is configured to mount a second component and orient the second component toward a second side of the body. The second side is different from the first side.

Also in accordance with the disclosure, there is provided a battery-compartment assembly including a battery compartment, a first sensing device, and a second sensing device. The battery compartment includes a body including a mounting cavity, and a first mounting arm and a second mounting arm each extending from the body toward a direction away from the mounting cavity. Each of the first mounting arm and the second mounting arm includes a mounting member. The first sensing device is mounted on the mounting member of the first mounting arm and faces away from a first side of the body. The second sensing device is mounted on the mounting member of the second mounting arm and faces away from a second side of the body. The second side is different from the first side.

Also in accordance with the disclosure, there is provided an unmanned aerial vehicle (UAV) including a battery-compartment assembly and a battery. The battery-compartment assembly includes a battery compartment, a first sensing device, and a second sensing device. The battery compartment includes a body including a mounting cavity, and a first mounting arm and a second mounting arm each extending from the body toward a direction away from the mounting cavity. Each of the first mounting arm and the second mounting arm includes a mounting member. The first sensing device is mounted on the mounting member of the first mounting arm and faces away from a first side of the body. The second sensing device is mounted on the mounting member of the second mounting arm and faces away from a second side of the body. The second side is different from the first side. The battery is received inside the mounting cavity.

### BRIEF DESCRIPTION OF THE DRAWINGS

FIG. 1 is a partial assembly diagram of an unmanned aerial vehicle (UAV) according to an example embodiment of the disclosure.

FIG. 2 is an exploded view of the UAV in FIG. 1.

FIG. 3 is an exploded view of the UAV in FIG. 1 from another view angle.

FIG. 4 is a schematic perspective assembly diagram of a battery-compartment assembly of the UAV in FIG. 3.

### DESCRIPTION OF MAIN COMPONENTS AND REFERENCE NUMERALS

UAV 100
First housing 10
First main body 12
First arm 14
Connecting member 16
Light-transmitting hole 160
Second housing 20
Second main body
Rotor assembly 26
Receiving space 10a
Battery-compartment assembly 30
Battery compartment 32
Body 34
First wall 341
Second wall 342
First side wall 343
Second side wall 344
Third side wall 345
Fourth side wall 346
Mounting cavity 340
Mounting arm 36
Extending member 362
First face 3622
Second face 3624
Side face 3626
Through hole 3620
Mounting member 364
Mounting plate 3642
Mounting face 3641
Back face
Mounting hole 3640
Holding member 366
Holding body 3662
Hatch 3663
Shield member 3664
Sensing device 37
Ultrasonic transmitter 3452
Ultrasonic receiver 3454
Optical-pulse transmitter 3462
Optical-pulse receiver 3464
Downward vision positioning system 38
Camera 382
Ultrasonic sensor 384

### DETAILED DESCRIPTION OF THE EMBODIMENTS

Example embodiments will be described with reference to the accompanying drawings, in which the same or similar numerals refer to the same or similar elements or the elements having the same or similar functions. It is intended that the embodiments be considered as example only and not to limit the scope of the disclosure.

As used herein, the terms “center,” “portrait,” “landscape,” “length,” “width,” “degree,” “up,” “down,” “front,” “back,” “left,” “right,” “vertical,” “horizontal,” “top,” “bottom,” “inner,” “outer,” “clockwise,” “counterclockwise,” or the like, indicating an orientation or position relationship shown in the drawings, are intended to describe example embodiments, instead of indicating or implying that the device or element being referred to has a particular orientation or should be constructed and operated in the particular orientation. Therefore, it is not intended to limit the present disclosure. The terms “first” and “second” used herein are intended to describe example embodiments, instead of indicating or implying that the relative importance or the number of the devices or elements being referred to. Therefore, devices or elements that are defined as “first” and “second” can include one or more devices or elements. The term “a plurality of” used herein are intended to refer to two or more, unless otherwise defined.

Unless otherwise defined, the terms “mounted,” “attached,” “connected,” used herein are intended to have a broad interpretation, for example, a fixed connection, a detachable connection, or an integrated connection, a mechanical connection, an electrical connection, or a communicative connection, a direct connection or an indirect connection via another element, an internal communication between two elements, or an interaction between the two elements. It can be appreciated by those of ordinary skill in the art that the above-described terms used herein can be interpreted according to the specific situations.

Unless otherwise defined, when a first component is referred to as “on” or “below” a second component, it is intended that the first component may be directly attached to the second component or may be indirectly attached to the second component via another component. When the first component is referred to as “above,” “over,” or “on” the second component, it is intended that the first component may be directly above or diagonally above the second component or a height of the first component may be higher than a height of the second component. When the first component is referred to as “below,” “under,” or “beneath” the second component, it is intended that the first component may be directly below or diagonally below the second component or the height of the first component may be lower than the height of the second component.

Different embodiments or examples are intended to describe different structures of the disclosure. The description of the components and arrangements of specific embodiments are described below. The specific embodiments are merely examples and not intended to limit the present disclosure. The reference numerals and/or reference letters may be repeated in different embodiments for simplifying the illustration, instead of indicating a relationship between the various embodiments and/or arrangements. Examples of various specific processes and materials are disclosed herein, but one of ordinary skill in the art can conceive the application of other processes and/or the use of other materials.

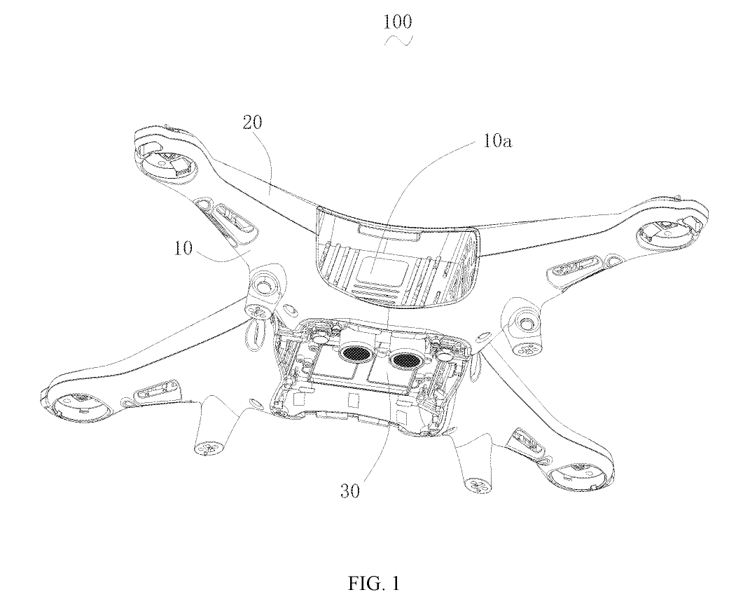

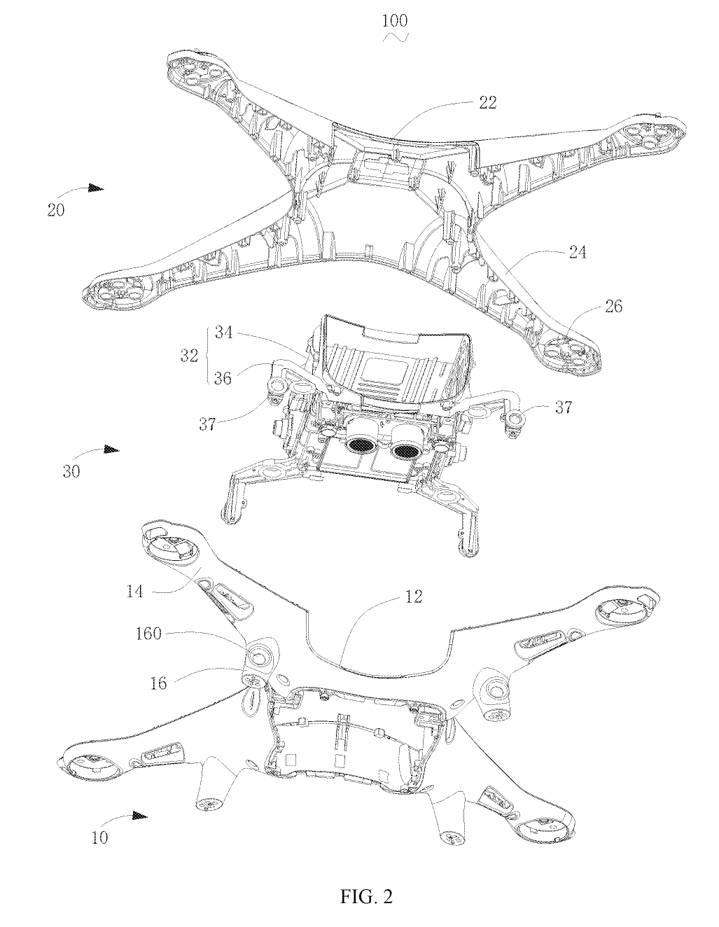

FIG. 1 is a partial assembly diagram of an unmanned aerial vehicle (UAV) 100 consistent with the disclosure. FIG. 2 is an exploded view of the UAV 100 consistent with the disclosure. In the example shown in FIGS. 1 and 2 and described below, the UAV 100 is a quad-rotor aircraft, i.e., an aircraft having four rotors. In some embodiments, the UAV 100 can also be a hexa-rotor aircraft, an octo-rotor aircraft, a twelve-rotor aircraft, or the like. In some embodiments, the UAV 100 can be a single-rotor aircraft. In some embodiments, the UAV 100 can be a fixed-wing aircraft or a rotor-fixed wing hybrid aircraft. The rotor assembly 26 includes a motor (not shown in FIGS. 1 and 2) and a propeller (not shown in FIGS. 1 and 2) connected to the motor. The motor can drive the propeller to rotate, which can provide the power for the UAV 100 to flight.

The UAV 100 includes a first housing 10, a second housing 20, a battery-compartment assembly 30, and a battery (not shown in FIGS. 1 and 2). The first housing 10 and the second housing 20 cooperate to form a receiving space 10a. The battery-compartment assembly 30 is received inside the receiving space 10a. The battery is received inside the battery-compartment assembly 30.

As shown in FIG. 2, the first housing 10 includes a first main body 12, two sets of first arms 14, and two sets of connecting members 16. The first housing 10 caves inwardly. Each set of first arms 14 includes two first arms 14. The number of the first arms 14 corresponds to the number of rotor assemblies 26 of the UAV 100. Each first arm 14 is configured to cooperate with the second housing 20 to arrange the corresponding rotor assembly 26 at a preset position. In some embodiments, the first arms 14 extend radically from the first main body 12. In some embodiments, the first arms 14 are symmetrically arranged around a center of the first main body 12. Each set of connecting members 16 includes two connecting members 16. Each connecting member 16 is extending from the corresponding first arm 14 toward a direction away from the receiving space 10a. A light-transmitting hole 160 is provided at each connecting member 16. The light-transmitting holes 160 of different sets of connecting members 16 can face away from different sides of the first main body 12. For example, the two light-transmitting holes 160 of one set of connecting members 16 can face away from a first side of the first main body 12 and the two light-transmitting holes 160 of the other set of connecting members 16 can face away from a second side of the first main body 12. The first side is different from the second side. The first side can be opposite to the second side or can be adjacent to the first side. In the example shown in FIG. 2, the first side is opposite to the second side.

The second housing 20 includes a second main body 22 and two sets of second arms 24. The second housing 20 caves inwardly. Each set of second arms 24 includes two second arms 24. The number of the second arms 24 corresponds to the number of the rotor assemblies 26 of the UAV 100 and the number of the first arms 14. Each second arm 14 is configured to cooperate with the corresponding first arm to arrange the corresponding rotor assembly 26 at the preset position. In some embodiments, the second arms 24 extends radically from the second main body 22. In some embodiments, the second arms 24 are symmetrically arranged around a center of the second main body 22. The second housing 20 can cooperate with the first housing 10, by one or more combinations of gluing, screwing, snapping, welding, or the like, to form the receiving space 10a.

The battery-compartment assembly 30 includes a battery compartment 32 and two sets of sensing devices 37.

The battery compartment 32 includes a body 34 and two sets of mounting arms 36.

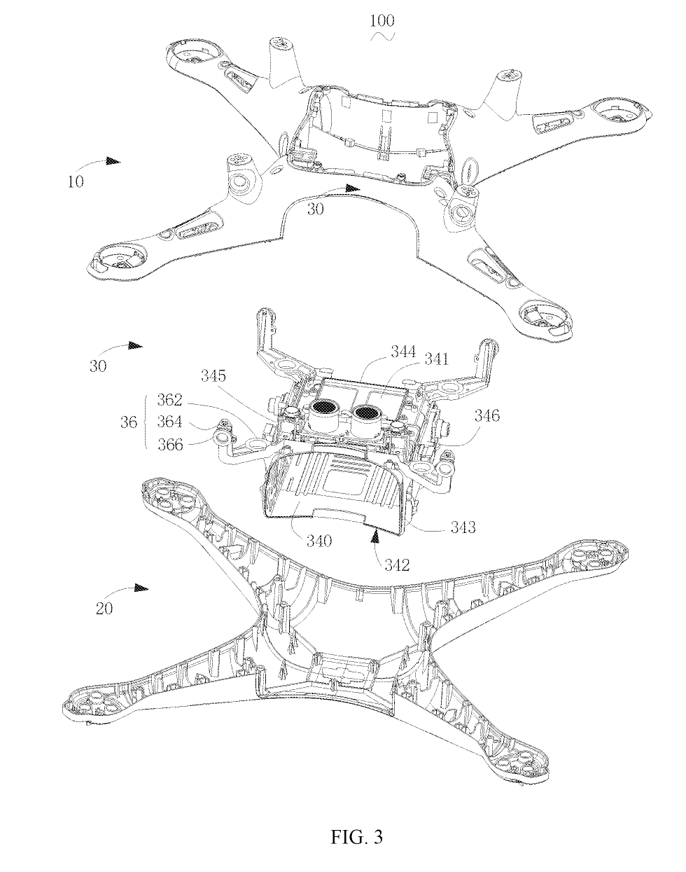

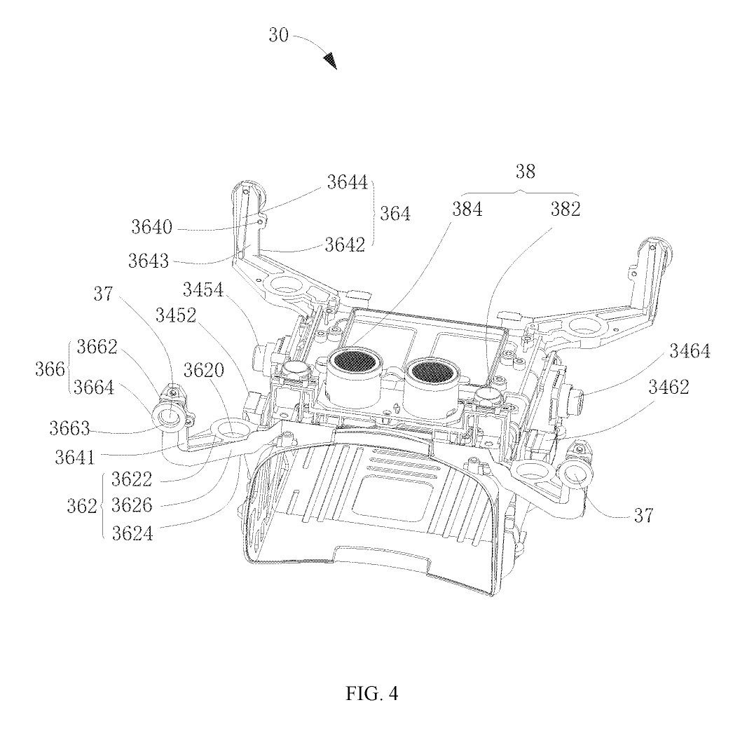

FIG. 3 is an exploded view of the UAV 100 from another view angle consistent with the disclosure. FIG. 4 is a schematic assembly diagram of the battery-compartment assembly 30 of the UAV 100 consistent with the disclosure. As shown in FIGS. 3 and 4, the body 34 has a rectangular-like structure and includes a first wall 341, a second wall 342 opposite to and spaced apart from the first wall 341, and four side walls connected to the first wall 341 and the second wall 342 (i.e., a first side wall 343, a second side wall 344, a third side wall 345, and a fourth side wall 346). One of the four side walls, for example, the first side wall 343, is provided with a mounting cavity 340 toward the body 34. The battery can be received inside the body 34. In some embodiments, the body 34 can have any bar structure, such as a cylinder structure, a bar structure having a cross-section with a pentagon-shape, a hexagon-shape, an octagon-shape, another regular shape, or an irregular shape.

The two sets of mounting arms 36 (i.e., a first set of mounting arms 36 and a second set of mounting arms 36) extend from the body 34 in directions away from the mounting cavity 340. Each set of mounting arms 36 includes two mounting arms 36. The four mounting arms 36 of two sets of mounting arms 36 extend from four corners of the first wall 341. In some embodiments, each mounting arm 36 includes an extending member 362, a mounting member 364, and a holding member 366.

An end of each extending member 362 is fixed to a corresponding corner of the body 34. Each extending member 362 includes a first face 3622, a second face 3624 opposite to the first face 3622, and a side face 3626 connected to the first face 3622 and the second face 3624. A through hole 3620 extending through from the first face 3622 to the second face 3624 is opened at each extending member 362. Opening the through holes 3620 can save materials and reduce costs.

The mounting members 364 are configured to mount components, such as the sensing devices 37. The mounting members 364 allow the components mounted on the two sets of mounting arms 36 to face away from two sides of the body 34. For example, the components mounted on one set of mounting arms 36 can face away from a first side of the body 34 corresponding to the first side wall 343 and the components mounted on the other set of mounting arms 36 can face away from a second side of the body 34 corresponding to the second side wall 344. The first side can be opposite to the second side or can be adjacent to the first side. The first side is opposite to the second side herein. In some embodiments, each mounting member 364 extends from the first face 3622 of the other end of each extending member 362 and forms an included angle with each extending member 362. The included angle may be any angle. In some embodiments, the angle can be 90 degrees. Each mounting member 364 includes a mounting plate 3642 and a reinforcing rib 3644. Each mounting plate 3642 extends perpendicularly from the first face 3622 and includes a mounting face 3641 configured to mount components and a back face 3643. Each reinforcing rib is connected to the first face 3622 and the back face 3643 to reinforce the mounting plate 3642.

Each holding member 366 includes a holding body 3662 and a shield member 3664. The holding bodies 3662 are configured to receive components, for example, the sensing devices 37. Each holding body 3662 can be mounted on the mounting face 3641 of the corresponding mounting member 364 by one or more combinations of gluing, screwing, snapping, welding, or the like. In some embodiments, a mounting hole 3640 is opened at each mounting member 364. Each holding body 3662 can be fixed to the corresponding mounting member 364 by being screwed into the mounting hole 3640. An opening 3663 is provided at a side of each holding body 3662 away from the mounting face 3641 to expose the components. Each shield member 3664 is mounted on each holding body 3662 and covers each opening 3663. The shield members 3664 may be made of plastic, glass, or the like, and are configured to protect the components contained in the holding bodies 3662, for example, protecting the components from impact or being contaminated by dust or impurities. In some embodiments, the holding members 366 can be omitted. In this situation, the components can be directly mounted on the mounting faces 3641 of the mounting members 364 by one or more combinations of gluing, screwing, snapping, welding, and the like.

Each set of sensing devices 37 includes two sensing devices 37. The two sets of sensing devices 37 are mounted at the holding bodies 3662 of the two sets of mounting arms 36 and face away from two sides of the body 34. The two sets of sensing devices 37 can be configured to sense through the shield members 3664. For example, the two sensing devices 37 mounted at the holding bodies 3662 of one set of mounting arms 36 can face away from the first side of the body 37 corresponding to the first side wall 343 and the two sensing devices 37 mounted at the holding bodies 3662 of the other set of mounting arms 36 can face away from the second side of the body 37 corresponding to the second side wall 344. The definition of the first side and the second side is the same as described-above. That is, the first side is different from the second side. The first side can be opposite to the second side or adjacent to the second side. In the example shown in FIGS. 3 and 4, the first side is opposite to the second side. One set of sensing devices 37 includes sensing devices of a visual sensing system. The other set of sensing devices 37 includes any one of the sensing devices of the visual sensing system, sensing devices of an ultrasonic sensing system, and sensing devices of a time sensing system. The sensing devices of the visual sensing system includes two cameras. The sensing devices of the ultrasonic sensing system includes an ultrasonic transmitter 3452 and an ultrasonic receiver 3454. The sensing devices of the time sensing system includes an optical-pulse transmitter 3462 and an optical-pulse receiver 3464. The circuit boards of the sensing devices 37 can be attached to the side faces 3626 to constrain the various elements and improve the stability.

In some embodiments, both of the two sets of sensing devices 37 can include the sensing devices of the visual sensing system. For example, one set of sensing devices 37 can face away from the first side (corresponding to the first side wall 343) includes two cameras arranged at the two mounting members 364 of the first set of mounting arms 36 and the other set of sensing devices 37 can face away from the second side (corresponding to the second side wall 344) also includes two cameras arranged at the two mounting members 364 of the second set of mounting arms 36. The two cameras face away from the first side (corresponding to the first side wall 343) can cooperate with each other to provide information and data for performing functions, such as the obstacle avoidance, positioning, speed measurement, navigation, or the like. The two cameras face away from the second side (corresponding to the second side wall 344) can also cooperate with each other to provide information and data for performing functions, such as the obstacle avoidance, positioning, speed measurement, navigation, or the like. The range of information and data provided for the UAV 100 can be increased and the limitations can be reduced.

According to the disclosure, the battery compartment 32, the battery-compartment assembly 30, and the UAV 100 can be provided with two sets of sensing devices 37, the two sets of sensing devices 37 face away from two sides of the body 34 by using the two sets of mounting arms 36, such that the range of information and data provided for the UAV 100 can be increased and the limitations can be reduced.

In some embodiments, one set of sensing devices 37 can include the sensing devices of the visual sensing system and the other set of sensing devices 37 can include the sensing devices of the ultrasonic sensing system. For example, one set of sensing devices 37 can face away from the first side (corresponding to the first side wall 343) includes two cameras arranged at the two mounting members 364 of the first set of mounting arms 36 and the other set of sensing devices 37 can face away from the second side (corresponding to the second side wall 344) includes the ultrasonic transmitter 3452 and the ultrasonic receiver 3454 arranged at the two mounting members 364 of the second set of mounting arms 36. The two cameras face away from the first side (corresponding to the first side wall 343) can cooperate with each other to provide information and data for performing functions, such as the obstacle avoidance, positioning, speed measurement, navigation, or the like. The ultrasonic transmitter 3452 and the ultrasonic receiver 3454 face away from the second side (corresponding to the second side wall 344) can also cooperate with each other to provide information and data for performing functions, such as the obstacle avoidance, positioning, speed measurement, navigation, or the like. The range of information and data provided for the UAV 100 can be increased and the limitations can be reduced.

In some embodiments, one set of sensing devices 37 can include the sensing devices of the visual sensing system and the other set of sensing devices 37 can include the sensing devices of the time sensing system. For example, one set of sensing devices 37 can face away from the first side (corresponding to the first side wall 343) includes two cameras arranged at the two mounting members 364 of the first set of mounting arms 36 and the other set of sensing devices 37 can face away from the second side (corresponding to the second side wall 344) includes the optical-pulse transmitter 3462 and the optical-pulse receiver 3464 arranged at the two mounting members 364 of the second set of mounting arms 36. The two cameras face away from the first side (corresponding to the first side wall 343) can cooperate with each other to provide information and data for performing functions, such as the obstacle avoidance, positioning, speed measurement, navigation, or the like. The optical-pulse transmitter 3462 and the optical-pulse receiver 3464 face away from the second side (corresponding to the second side wall 344) can also cooperate with each other to provide information and data for performing functions, such as the obstacle avoidance, positioning, speed measurement, navigation, or the like. The range of information and data provided for the UAV 100 can be increased and the limitations can be reduced.

When the battery-compartment assembly 30 is received in the receiving space 10a, the body 34 can be received in a cave corresponding to the first main body 12 and the second main body 22 of the receiving space 10a, extending members 362 can be received in positions of the receiving space 10a corresponding to the first arms 14 and the second arms 24, the mounting members 364 can be received in positions of the receiving space 10a corresponding to the connecting members 16, the sensing devices 37 can correspond to the light-transmitting holes 160 at the connecting members 16 and can sense information through the light-transmitting holes 160, the first wall 341 can be close to the first housing 10, and the second wall 342 can be close to the second housing 20.

In some embodiments, at least one of the four side walls can also be provided with the sensing devices of the ultrasonic sensing system or the sensing devices of the time sensing system. For example, the sensing devices of the ultrasonic sensing system can be provided at the third side wall 345, and the sensing devices of the ultrasonic sensing system includes the ultrasonic transmitter 3452 and the ultrasonic receiver 3454. The sensing devices of the time sensing system can be provided at the fourth side wall 346 and the sensing devices of the time sensing system includes the optical-pulse transmitter 3462 and the optical-pulse receiver 3464. In this situation, the ultrasonic transmitter 3452 and the ultrasonic receiver 3454 at the third side wall 345 can cooperate with each other to provide information and data for performing functions, such as the obstacle avoidance, positioning, speed measurement, navigation, or the like. The optical-pulse transmitter 3462 and the optical-pulse receiver 3464 at the fourth side wall 346 can cooperate with each other to provide information and data for performing functions, such as the obstacle avoidance, positioning, speed measurement, navigation, or the like. The range of information and data provided for the UAV 100 can be further increased and the limitations can be further reduced.

The position arrangement of the mounting arms 36 is not limited to the four mounting arms of the two sets of mounting arms extending from the four corners of the first wall 341 as described above.

In some embodiments, the two mounting arms 36 of one set of mounting arms 36 can extend from the two corners of the first wall 341, and the two mounting arms 36 of the other set of mounting arms 36 can extend from one of the four side walls. In this situation, at least one of the four side walls, except for the side wall provided with the mounting arms 36, can also be provided with the sensing devices of the ultrasonic sensing system or the sensing devices of the time sensing system. For example, the two mounting arms 36 of one set of mounting arms 36 can extend from the two corners of the first wall 341 and the two sensing devices 37 provided at the two mounting arms 36 extending from the two corners can face away from the first side (corresponding to the first side wall 343), the two mounting arms 36 of the other set of mounting arms 36 can extend from the second side wall 344, or the third side wall 345, or the fourth side wall 346. When the two mounting arms 36 of the other set of mounting arms 36 extend from the second side wall 344, the third side wall 345 and/or the fourth side wall 346 can also be provided with the sensing devices of the ultrasonic sensing system or the sensing devices of the time sensing system. When the two mounting arms 36 of the other set of mounting arms 36 extend from the third side wall 345, the second side wall 344 and/or the fourth side wall 346 can also be provided with the sensing devices of the ultrasonic sensing system or the sensing devices of the time sensing system. When the two mounting arms 36 of the other set of mounting arms 36 extend from the fourth side wall 346, the second side wall 344 and/or the third side wall 345 can also be provided with the sensing devices of the ultrasonic sensing system or the sensing devices of the time sensing system. As such, the range of information and data provided for the UAV 100 can be further increased and the limitations can be further reduced.

In some embodiments, the two mounting arms 36 of one set of mounting arms 36 can extend from one of the four side walls, and the two mounting arms 36 of the other set of mounting arms 36 can extend from another one of the four side walls. In this situation, at least one of the four side walls, except for the side walls provided with the mounting arms 36, can also be provided with the sensing devices of the ultrasonic sensing system or the sensing devices of the time sensing system. For example, the two mounting arms 36 of one set of mounting arms 36 can extend from the first side wall 343 and the two mounting arms 36 of the other set of mounting arms 36 can extend from the second side wall 344, or the third side wall 345, or the fourth side wall 346. When the two mounting arms 36 of the other set of mounting arms 36 extend from the second side wall 344, the third side wall 345 and/or the fourth side wall 346 can also be provided with the sensing devices of the ultrasonic sensing system or the sensing devices of the time sensing system. When the two mounting arms 36 of the other set of mounting arms 36 extend from the third side wall 345, the second side wall 344 and/or the fourth side wall 346 can also be provided with the sensing devices of the ultrasonic sensing system or the sensing devices of the time sensing system. When the two mounting arms 36 of the other set of mounting arms 36 extend from the fourth side wall 346, the second side wall 344 and/or the third side wall 345 can also be provided with the sensing devices of the ultrasonic sensing system or the sensing devices of the time sensing system. As such, the range of information and data provided for the UAV 100 can be further increased and the limitations can be further reduced.

In some embodiments, the battery-compartment assembly 30 can also include a downward vision positioning system 38 mounted at the first wall 341. The downward vision positioning system 38 includes two cameras 382 and two ultrasonic sensors 384. In some other embodiments, the downward vision positioning system 38 can include one camera 382 and one ultrasonic sensor 384. The downward vision positioning system 38 can provide information and data for performing functions, such as the obstacle avoidance, positioning, speed measurement, navigation, or the like. The range of information and data provided for the UAV 100 can be further increased and the limitations can be further reduced.

In some embodiments, the number and arrangement of the mounting arms 36 of the battery-compartment assembly 30 and the number and arrangement of the sensing devices 37 may be any combination of the above-described embodiments, and the detailed description thereof is omitted here.

As used herein, the terms “certain embodiments”, “an embodiment”, “some embodiments”, “an example embodiment”, “an example”, “a specific example”, “some examples”, or the like, are intended to mean that a specific feature, structure, material, or characteristic described in connection with the embodiment or example is included in at least one embodiment or example of the disclosure. The above-described terms do not necessarily refer to the same embodiment or example. Furthermore, the specific features, structures, materials, or characteristics described may be combined in any suitable manner in any one or more of the embodiments or examples.

The terms “first” and “second” used herein are intended to describe example embodiments, instead of indicating or implying that the relative importance or the number of the devices or elements being referred to. Therefore, devices or elements that are defined as “first” and “second” can include one or more devices or elements. The term “a plurality of” used herein are intended to refer to at least two, such as two, three, or the like, unless otherwise defined.

It is intended that the embodiments be considered as example only and not to limit the scope of the disclosure. Those skilled in the art will be appreciated that any modification or equivalents to the disclosed embodiments are intended to be encompassed within the scope of the present disclosure.

What is claimed is:

1. A battery compartment comprising:
a body including a mounting cavity; and
a first mounting arm and a second mounting arm each extending from the body toward a direction away from the mounting cavity;
wherein:
each of the first mounting arm and the second mounting arm includes a mounting member;
the mounting member of the first mounting arm is configured to mount a first component and orient the first component toward a first side of the body; and
the mounting member of the second mounting arm is configured to mount a second component and orient the second component toward a second side of the body, the second side being different from the first side.

2. The battery compartment of claim 1, wherein the first side and the second side are opposite to each other or adjacent to each other.

3. The battery compartment of claim 1, wherein:
the body includes:
a first wall;
a second wall opposite to the first wall; and
four side walls connecting the first wall and the second wall; and
the mounting cavity opens from one of the four side walls toward an interior of the body.

4. The battery compartment of claim 3, wherein:
each of the first mounting arm and the second mounting arm extends from one corner of the first wall; or
the first mounting arm extends from the corner of the first wall, and the second mounting arm extends from one of the four side walls; or
the first mounting arm extends from the one of the four side walls, and the second mounting arm extends from another one of the four side walls.

5. The battery compartment of claim 1, wherein:
each of the first mounting arm and the second mounting arm includes an extending member having one end fixed to the body; and
for each one of the first mounting arm and the second mounting arm, the mounting member extends from another end of the extending member and forms an included angle with the extending member.

6. The battery compartment of claim 5, wherein the extending member includes:
a first face;
a second face opposite to the first face;
a side face connecting the first face and the second face; and
a through hole extending from the first face to the second face.

7. The battery compartment of claim 6, wherein the mounting member extends perpendicularly from the first face of the extending member.

8. The battery compartment of claim 6, wherein the mounting member includes:
a mounting plate extending perpendicularly from the first face and including:
a mounting face configured to mount a corresponding one of the first component and the second component; and
a back face; and
a reinforcing rib connecting the first face and the back surface.

9. The battery compartment of claim 5, wherein each of the first mounting arm and the second mounting arm further includes:
a holding member including a holding body mounted on the mounting member and configured to receive a corresponding one of the first component and the second component; and
an open provided at the holding body.

10. The battery compartment of claim 9, wherein the holding member further includes a shield member mounted at the holding body and covering the opening.

11. The battery compartment of claim 9, wherein the holding member is fixed to the mounting member by at least one of gluing, screwing, snapping, or welding.

12. A battery-compartment assembly comprising:
a battery compartment including:
a body including a mounting cavity; and
a first mounting arm and a second mounting arm each extending from the body toward a direction away from the mounting cavity, each of the first mounting arm and the second mounting arm including a mounting member;
a first sensing device mounted on the mounting member of the first mounting arm and facing a first side of the body; and
a second sensing device mounted on the mounting member of the second mounting arm and facing a second side of the body, the second side being different from the first side.

13. The battery-compartment assembly of claim 12, wherein:
the first sensing device includes a sensing device of a visual sensing system; and
the second sensing devices includes at least one of another sensing device of the visual sensing system, a sensing device of an ultrasonic sensing system, and a sensing device of a time sensing system.

14. The battery-compartment assembly of claim 13, wherein:
the visual sensing system includes two cameras; and/or
the ultrasonic sensing system includes an ultrasonic transmitter and an ultrasonic receiver; and/or
the time sensing system includes an optical-pulse transmitter and an optical-pulse receiver.

15. The battery-compartment assembly of claim 12, wherein the first side and the second side are opposite to each other or adjacent to each other.

16. The battery-compartment assembly of claim 12:
wherein:
the body includes:
a first wall;
a second wall opposite to the first wall; and
four side walls connecting the first wall and the second wall; and
the mounting cavity opens from one of the four side walls toward an interior of the body;
the battery-compartment assembly further comprising:
a downward vision positioning system mounted at the first wall.

17. The battery-compartment assembly of claim 16, wherein:
the first sensing device includes a sensing device of a visual sensing system; and
the second sensing devices includes at least one of another sensing device of the visual sensing system, a sensing device of an ultrasonic sensing system, and a sensing device of a time sensing system.

18. The battery-compartment assembly of claim 16, wherein the downward vision positioning system includes:
two cameras and two ultrasonic sensors; or
one camera and two ultrasonic sensors.

19. The battery-compartment assembly of claim 16, further comprising:
a sensing device of an ultrasonic sensing system or a sensing device of a time sensing system on one of the four side walls.

20. The battery-compartment assembly of claim 19, wherein the first mounting arm and the second mounting arm are not provided on the one of the four side walls.

21. An unmanned aerial vehicle (UAV) comprising:
a battery-compartment assembly including:
a battery compartment including:
a body including a mounting cavity; and
a first mounting arm and a second mounting arm each extending from the body toward a direction away from the mounting cavity, each of the first mounting arm and the second mounting arm including a mounting member;
a first sensing device mounted on the mounting member of the first mounting arm and facing a first side of the body; and
a second sensing device mounted on the mounting member of the second mounting arm and facing a second side of the body, the second side being different from the first side; and
a battery received in the mounting cavity.

22. The UAV of claim 21, further comprising:
a first housing including a plurality of light-transmitting holes; and
a second housing;
wherein,
the first housing and the second housing form a receiving space; and
the first sensing device and the second sensing device perform sensing through the plurality of light-transmitting holes.

23. The UAV of claim 22, wherein the first housing includes:
a main body;
a plurality of arms extending from the main body; and
a plurality connecting members each extending from one of the plurality arms;
wherein:
each of the plurality of light-transmitting holes is provided on one of the plurality of connecting members; and
the plurality light-transmitting holes face away from two sides of the main body.
